(19) United States
(12) Patent Application Publication
(10) Pub. No.: US 2008/0098812 A1
(43) Pub. Date: May 1, 2008

(54) Stillwell Apparatus

(76) Inventor: Craig T. Nelson, St. John, IN (US)

Correspondence Address: WHYTE HIRSCHBOECK DUDEK S C, 555 EAST WELLS STREET, SUITE 1900, MILWAUKEE, WI, 53202, US

(21) Appl. No.: 11/874,999

(22) Filed: Oct. 19, 2007

Related U.S. Application Data
(60) Provisional application No. 60/863,191, filed on Oct. 27, 2006.

(51) Int. Cl. G01P 1/02; G01D 21/00

(52) U.S. Cl. 73/431; 73/866.5

(57) ABSTRACT

This invention involves a new housing for a liquid level detection device. More particularly, the new stillwell apparatus comprises, at least one tubular section, a means for extending the length of the stillwell, a conduit for delivering a cleansing solution to the bottom of the tubular sections, a gas inlet tube for determination of the presence of hazardous gases, and a means for pressure equalization. In addition this invention reveals novel installation, removal and cleansing methods making it possible to install, remove, and cleanse the stillwell from an exterior of a vessel, thereby eliminating the need for highly trained personnel to enter the vessel in order to install, maintain, cleanse, or remove the stillwell.

### CROSS-REFERENCE TO RELATED APPLICATION

This application claims the benefit of U.S. provisional patent application No. 60/863,191 entitled “Stillwell Apparatus” filed on Oct. 27, 2006, which is hereby incorporated by reference herein.

### BACKGROUND OF THE INVENTION

1. Field of the Invention

This invention relates to a casing for housing a liquid level detection device. More particularly, this invention relates to a new stillwell apparatus comprising, at least one tubular section, a means for extending the length of the stillwell, a conduit for delivering a cleansing solution to the bottom of the tubular sections, a gas inlet tube for determination of the presence of hazardous gases, and an installation and removal method making it possible to install and remove the stillwell from an exterior of a vessel, thereby eliminating the need to enter the vessel in order to install, maintain, or remove the stillwell.

2. Description of Related Art

A stillwell protects an analytical instrument from damage caused by the solution it is designed to analyze and any impurities suspended within that solution. The stillwell also stabilizes the analytical instrument from turbulence, which may dislodge the analytical instrument and give rise to inaccurate data.

In vessels such as underground storage tanks, chemical reaction vessels, water tanks, water wells, or municipal waste containers, highly trained personnel must enter the vessel to install, clean, maintain, repair, or remove the stillwell. The highly trained personnel often encounter extremely hazardous conditions upon entrance into such vessels.

Prior to entry, the highly trained personnel must follow strict safety guidelines. Generally, the strict safety guidelines, outlined for example by OSHA regulations governing permit required confined spaces, require highly trained personnel, specialized equipment, and complex procedures. The extreme hazards associated with entry into the vessel for installation, maintenance, or removal of the stillwell as well as the time involved; make for a dangerous and hazardous process.

In many applications, particularly those associated with municipal and wastewater, stillwells extend very close to the bottom of the vessel. Frequently the solution to be analyzed contains precipitates. When precipitates accumulate near the bottom of the vessel, the stillwell gets plugged and the steady flow of liquid into and out of the stillwell is interrupted which causes inaccurate readings of the analytical device. The precipitates cause additional problems when the analytical detection equipment is involved with automation of pumps, alarms, recording instruments, and subsequent processing steps. The consequences of inaccuracies associated with analytical detection are clear to those skilled in the art of analyzing liquids.

Stillwells routinely require cleansing in order to insure fluid communication with the analytical device therein. Removal or displacement of the precipitates plugging the stillwell generally requires that personnel enter the vessel and/or that personnel remove the analytical instrument from the stillwell and purge the precipitates from the lower end of the stillwell. Both cleansing means require interruption of data collection.

In addition to the aforementioned safety precautions and OSHA regulations governing such areas, personnel must also evaluate the presence of hazardous substances within the vessel and follow additional procedures developed by the National Fire Protection Association. Some vessels contain combustible liquids. Others contain combustible gases.

Gaseous substances sometimes escape from the vessel. The gases may be toxic and flammable. Gaseous substances may also enter the vessel from the exterior and cause problems. If oxygen-containing gases enter the vessel and the vessel contains combustible substances, a spark may lead to combustion.

Those concerned with these and other problems recognize the need for an improved stillwell apparatus.

### BRIEF SUMMARY OF THE INVENTION

It is therefore an object of the present invention to provide a novel stillwell apparatus, which minimizes or eliminates the need for personnel to enter a hazardous location such as the vessel, tank, pit or well containing the liquid to be analyzed. Another object of the invention is to provide a stillwell apparatus that can be installed, maintained, or removed from an exterior of the vessel. Another object of the present invention is to provide a novel stillwell apparatus which minimizes or eliminates the need to maintain, replace, or remove the stillwell. A further object of the present invention is to provide a novel stillwell apparatus which contains means for sampling and monitoring gases without exposing personnel to toxic substances, hazardous conditions, and circumstances leading to combustion. It is still another object of the present invention to provide a novel stillwell apparatus which has means for cleansing the lower end of the stillwell without subjecting personnel to hazardous conditions. Yet another object of the present invention is to provide a novel stillwell apparatus with means for easy movement of liquids to be analyzed into and out of the stillwell. A further object of the present invention is to provide a novel stillwell apparatus which utilizes materials that lack an ability to spark and or corrode.

These and other objects of the invention are accomplished by providing a novel stillwell apparatus having a generally tubular shape with an interior to house the instrument for analyzing liquids, an exterior for attaching the conduit through which the cleansing solution can be transferred from the top of the vessel to the bottom of the stillwell, an upper section having means for attachment to an exterior of a vessel, and a lower section for allowing entrance of fluids to be analyzed, and a means for extending the length of the stillwell apparatus. The upper section also includes a means through which gases can travel and a means for pressure equalization.

The exterior of the stillwell comprises means for attachment of the conduit through which the cleansing solution travels. The means for attachment of the conduit to the exterior of the vessel comprises tabs.

The conduit allows the cleansing solution to flow parallel to the stillwell apparatus from an external source of cleansing solution at the top of the stillwell apparatus to the bottom of the stillwell apparatus. The conduit through which the cleansing solution flows further comprises a valve at the conduit upper end for attachment to the external source of cleansing solution. The conduit lower end comprises a nozzle for directing the cleansing solution at the portholes and/or lower end openings of the lower section of the stillwell.

The external source of cleansing solution at the top of the stillwell apparatus houses a cleansing solution. The cleansing solution comprises gaseous cleansers, solid cleansers, liquid cleansers, and mixtures of cleansers. The cleansing solution may also be water or compressed air.

The upper section of the stillwell comprises means for attachment of the stillwell to the outside of a vessel. The upper section of the stillwell also comprises means for entrance or exit of gases. In one embodiment the means for entrance or exit of gases comprises a gas inlet tube with a valve. The upper section also comprises means for pressure equalization. In one embodiment the means for pressure equalization comprises vent holes.

The upper section of the stillwell also comprises a lid. The lid has an open position and a closed position. The analytical device is inserted into the stillwell when the lid is in the open position.

The liquid to be analyzed flows into and out of the stillwell in the lower section of the stillwell apparatus. The lower section contains a plurality of portholes, which allow passage of the fluid to be analyzed into and out of the stillwell apparatus.

The stillwell apparatus comprises an upper section and a lower section and a means for extending the length of the stillwell. In one embodiment, the means for extending the length of the stillwell comprises a middle section. The stillwell length can be extended by a inserting a plurality of middle sections in between the upper section and the lower section. The extended stillwell comprises an elongate tubular structure with the lower section, the plurality of middle sections for extending the length of the stillwell apparatus and the upper section with fluid flow communication there between all sections.

In another embodiment, the stillwell apparatus comprises a one-piece stillwell. The apparatus comprises a generally tubular shape with an interior to house the instrument for analyzing liquids and an exterior for attaching the conduit through which the cleansing solution can be transferred from the top of the vessel to the bottom of the stillwell. The upper section and lower section comprise one uninterrupted piece. The upper section comprises a means for attachment to the exterior of a vessel and the opposing lower section comprises portholes which allow entrance of the fluid to be analyzed. The upper section also comprises vent holes for pressure equalization, and the gas inlet tube with the gas inlet tube valve. The exterior of the one piece stillwell comprises means for attaching the conduit through which cleansing solution passes.

Another embodiment includes a two piece stillwell wherein the upper section and lower section are two separate units that are sealingly connected to each other. The connection of the upper section to the lower section includes conventional mechanical coupling means. In one embodiment, the lower section is sealingly connected to the upper section with threaded fasteners. The lower section first end has a flange with openings therein. The upper section second end also has a flange with openings therein. The lower section first end is sealingly connected to the upper section by aligning the lower section first end flange with the upper section second end flange and inserting threaded fasteners or bolts through the openings and using a nut and washer to hold them in place.

The two piece stillwell upper section comprises the lid, the gas inlet tube, and the means for pressure equalization. The stillwell lower section comprises portholes, The stillwell exterior comprises a removably attached conduit through which cleansing solution travels from an exterior source of cleansing solution to the bottom of the stillwell.

In a more preferred embodiment, the stillwell apparatus comprises a multi-piece stillwell. The multipiece stillwell comprises a plurality of lengthening means appended there between the upper section and the lower section and in fluid flow communication with both the upper section and the lower section. The cross section of the middle section equals the cross section of the upper and lower sections and provides a consistent bore diameter throughout the entire length of the stillwell apparatus.

In the multi-piece stillwell, the upper section comprises a first end and an opposing second end. The upper section first end has means for connecting to the top of the vessel containing liquid to be analyzed. The upper section first end includes a flange with openings therein for connecting to the top of the vessel with threaded fasteners.

The upper section second end comprises means for sealingly connecting to a middle section in order to extend the length of the stillwell. The middle section comprises a tubular structure with a first end and an opposing second end. The middle section second end comprises means for sealingly connecting to the lower section first end. The middle section first end comprises means for sealingly connecting to the upper section in order to allow fluid flow communication therewith.

In the more preferred embodiment, the middle section comprises means for sealingly connecting to the lower section and the upper section comprises flanges with flange openings and insertion of threaded fasteners or bolts through the flange openings using nuts and washers to hold them in place.

The middle section first end is sealingly connected to the upper section second end to allow fluid flow communication. The middle section first end has a flange with openings therein and the upper section second end has a flange with openings therein. When threaded fasteners or bolts extend through the openings and are held in place by the nuts and washers, the middle section extends the length of the stillwell.

The upper section is attached to the top of the vessel containing liquid to be analyzed. The upper section has a means for connecting to the top of the vessel. In a preferred embodiment, the upper section first end includes a flange with openings therein for connecting to the top of the vessel with threaded fasteners.

In addition, the upper section has a lid for establishing an airtight seal when the lid is in the closed position. When the lid is in the open position, the analytical device can be inserted into or removed from the interior of the stillwell apparatus.

The upper section has a gas inlet tube for preventing or allowing movement of gas into or out of the stillwell. The gas inlet tube provides a means for allowing personnel to sample the atmospheric conditions inside the vessel to determine whether it is safe to proceed with removing the lid. The gas inlet tube has a valve and the valve has an open position and a closed position. When the gas inlet tube valve is in the open position, gas may move in or out of the stillwell through the gas inlet tube thereby allowing the conditions inside the vessel to be monitored by using any conventional gas monitoring device designed for such use. When the gas inlet tube valve is in the closed position, gas is prevented from moving through the gas inlet tube and therefore gas may not move in or out of the stillwell.

Another novel feature of the improved stillwell apparatus includes a means for allowing pressure equalization. The means for allowing pressure equalization comprises vent openings in the upper section in order to allow movement of liquid and gases into and out of the still well. The location of the vent openings in the upper section is critical to maintain an appropriate pressure within vessel and within the stillwell apparatus.

A method for installation of the improved stillwell involves inserting the improved stillwell from an exterior of a vessel through an appropriate opening and fastening to the vessel, thereby eliminating the need to enter the vessel in order to install, maintain, or remove the stillwell. A preferred method for installation of the stillwell comprises the steps of inserting the stillwell apparatus into a vessel, sealingly connecting the stillwell apparatus to the vessel, and extending the length of the stillwell apparatus. Another preferred method for installation of the stillwell apparatus includes the steps of inserting the stillwell apparatus into the vessel, increasing the length of the stillwell apparatus, and connecting the stillwell apparatus to the vessel.

Another preferred method for installation of a one piece stillwell comprises the steps of inserting the stillwell apparatus into a vessel, sealingly connecting the stillwell apparatus to the vessel, and connecting the cleansing conduit to an exterior source of cleansing solution.

A more preferred method for installation of a two piece stillwell comprises the steps of inserting the lower section of the stillwell apparatus into the vessel, connecting the lower section of the stillwell apparatus to the upper section of the stillwell apparatus, connecting the cleansing conduit lower section to the cleansing conduit upper section, connecting the upper section to the exterior of the vessel, and connecting the cleansing conduit upper section to the exterior source of cleansing solution.

Another method for installation of the two piece stillwell comprises the steps of inserting the lower section of the stillwell apparatus into the vessel, sealingly attaching the lower section first end to the upper section second, sealingly attaching the cleansing conduit lower section conduit to the cleansing conduit upper section, attaching the upper section first end to the exterior of the vessel, and connecting the cleansing conduit upper section to an exterior source of cleansing solution.

A most preferred method for installation of a multi-piece stillwell comprises the steps of inserting the lower section into the vessel, sealingly connecting the lower section to the middle section, sealingly connecting the cleansing conduit lower section to the cleansing conduit middle section, inserting the middle section into the vessel, sealingly connecting the middle section to the upper section, sealingly connecting the cleansing conduit middle section to the cleansing conduit upper section, inserting the upper section into the vessel, sealingly connecting the upper section to the vessel, and sealingly connecting the cleansing conduit upper section to an exterior source of cleansing solution.

### BRIEF DESCRIPTION OF THE DRAWINGS

FIG. 1 is a perspective view of a preferred embodiment of the new two piece stillwell apparatus.

FIG. 2 is a perspective view of a preferred embodiment of the new stillwell apparatus with inclusion of a middle section

FIG. 3 is a perspective view of a preferred embodiment of the new one piece stillwell apparatus.

FIG. 4 is a cross sectional view of the upper section first end, the lid, and the gas inlet tube.
100 embodies a length of an upper section of the two piece stillwell
101 embodies the upper section first end flange
102 embodies the upper section first end flange openings
103 embodies the lid
104 embodies threaded fasteners for the lid
105 embodies a lid gasket
106 embodies a gas inlet tube
107 embodies an upper section conduit for delivering cleansing solution
108 embodies an upper section
109 embodies a gusset
110 embodies vent openings
111 embodies an upper section second end
112 embodies a threaded fastener for connecting an upper section second end
113 embodies a tab for attachment of the conduit for delivering cleansing solution
114 embodies the upper section first end
115 embodies lid openings
116 embodies upper section first end flange lid attachment openings
117 embodies a gas inlet tube valve
200 embodies a length of a lower section
201 embodies a lower section conduit for delivering the cleansing solution
202 embodies a nozzle on the conduit for delivering the cleansing solution
203 embodies a lower section
204 embodies a lower section first end
205 embodies tabs
206 embodies port holes
207 embodies a lower section second end
300 embodies a length of a middle section
301 embodies a middle section conduit for delivering cleansing solution
302 embodies a middle section
303 embodies a middle section second end
304 embodies a middle section first end
305 embodies tabs
306 embodies an upper section cleansing conduit first end
307 embodies an upper section cleansing conduit second end
308 embodies a middle section cleansing conduit first end
309 embodies a middle section cleansing conduit second end
310 embodies a lower section cleansing conduit first end
311 embodies a lower section cleansing conduit second end
312 embodies a cleansing conduit
313 embodies a length of a one piece stillwell
314 embodies a cleansing solution inlet valve

FIG. 5 is a sketch of a recessed frame.

FIG. 6 is a sketch of a lid for the frame of FIG. 5.

FIG. 7 is a top, bottom, and side view of the frame of FIG. 5.

FIG. 8 is a sketch of support brackets and base plates.

### DETAILED DESCRIPTION OF THE INVENTION

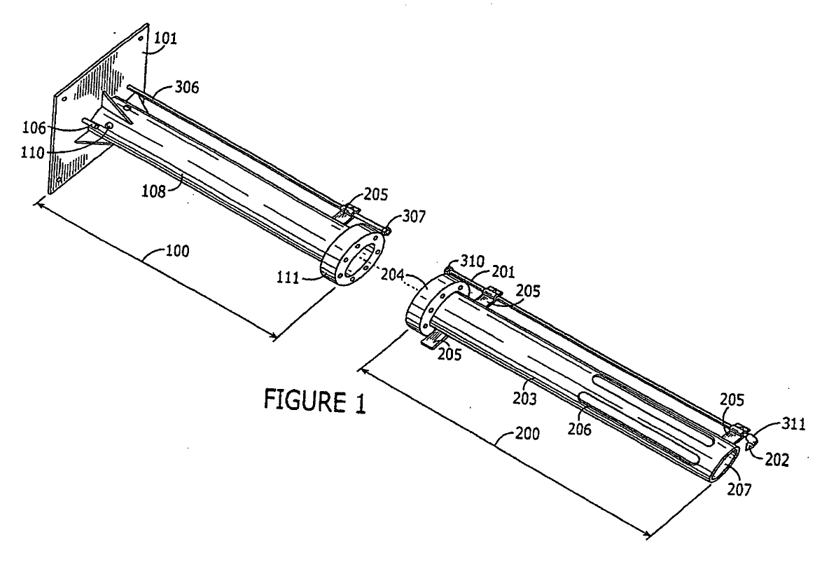

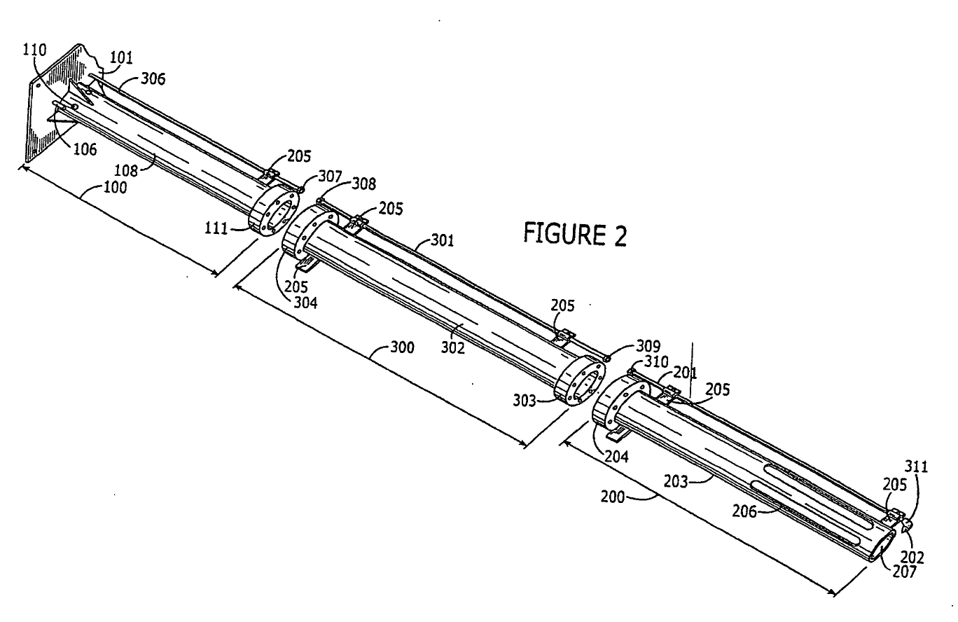

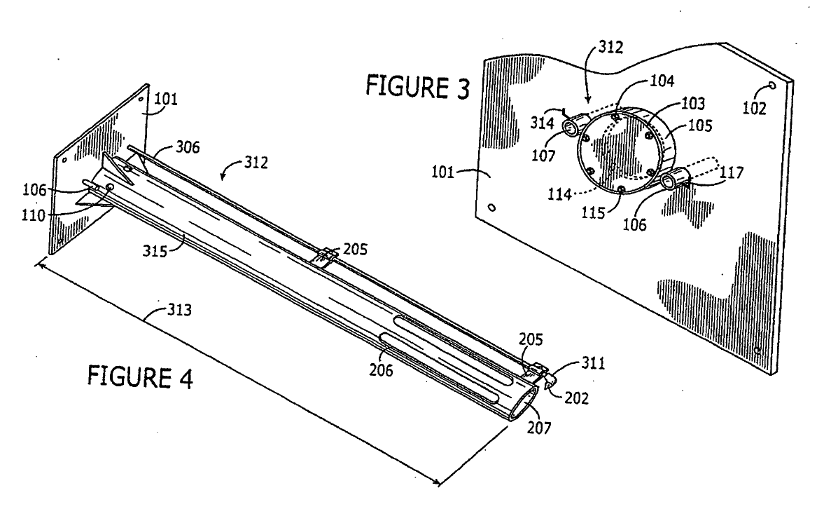

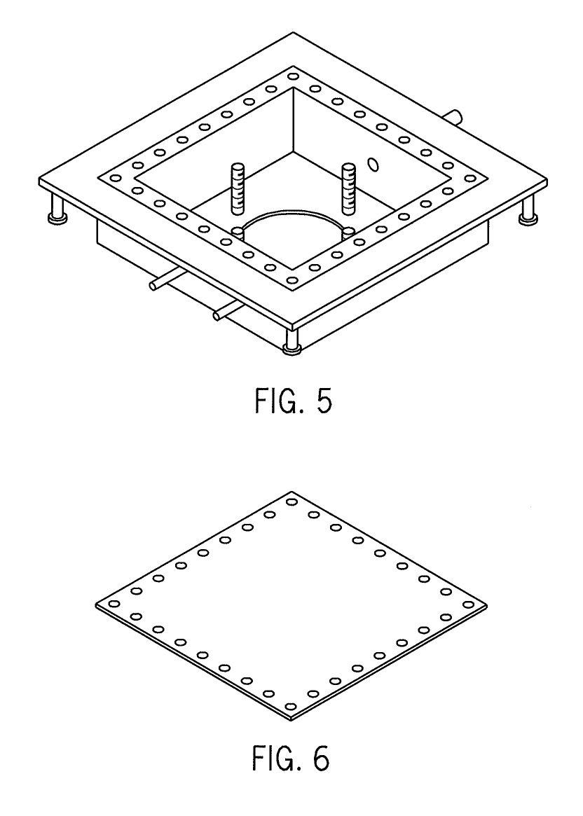

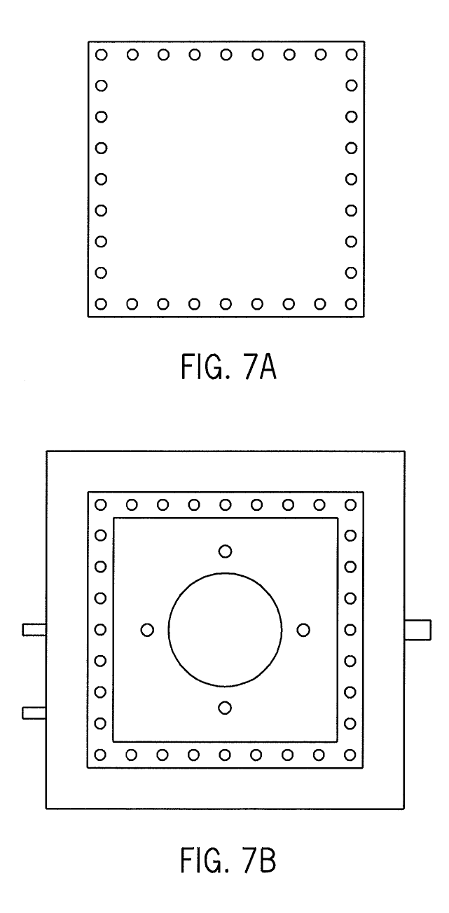

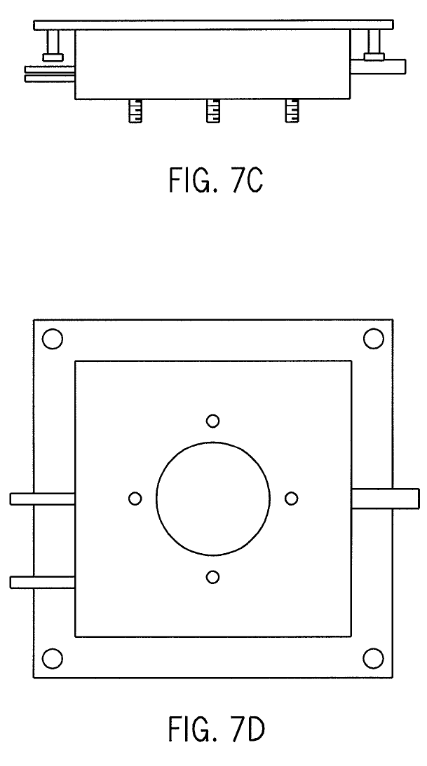

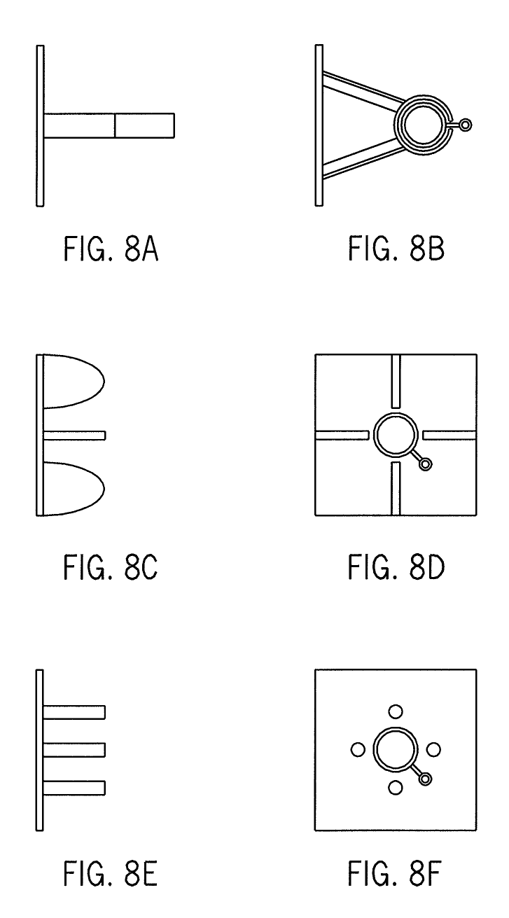

Referring now to the drawings wherein like reference numerals designate identical or corresponding parts throughout the several views, FIG. 1 shows an embodiment of the present invention. Referring to FIG. 1, port holes (206) are located adjacent to the lower section second end (207) in order to allow the solution into and out of the stillwell apparatus.

The lower section (203) has tabs (205) for connecting the lower section conduit (201) to the exterior of the lower section (203). The tabs (205) serve to secure the conduit (201) to the exterior of the stillwell and also to temporarily suspend the respective section over the vessel opening while the next section is placed in position for assembly and sealing connection. The nozzle (202) is aligned with the lower section second end (202) which allows for cleansing of the stillwell with cleansing solution from the conduit (201). The conduit comprises a flush pipe, which delivers cleansing solution from an exterior source if and when the lower section second end (207) gets clogged with debris.

In a multipiece stillwell, the lower section first end (204) contains a flange with openings therein for sealingly connecting to the upper section second end (111) with threaded fasteners (112). The connection between the lower section first end (204) and the upper section second end (111) allows for fluid communication there between the lower section (203) and the upper section (108).

Once the upper section second end (111) is sealingly connected to the lower section first end (204), the upper section first end (114) can be connected to the exterior of the vessel by sealingly connecting the upper section first end flange (101) to the exterior of the vessel. The upper section first end (114) may be sealingly connected with conventional mechanical coupling means to the exterior of the vessel. The upper section first end flange (101) has openings (102) for use of threaded fasteners.

The cleansing conduit lower section (201) is connected to the cleansing conduit upper section (107) via conventional mechanical means which allow for fluid communication therebetween the entire length of the conduit. Then the exterior source of cleansing solution is connected to a cleansing solution inlet valve (314) if the port holes (206) and/or the lower section second end (207) become clogged.

The analytical device can be inserted into the interior of the new stillwell apparatus while the lid (103) is in the open position. The lid (103) can be sealingly attached to the upper section first end (114) with threaded fasteners (104) or other standard mechanical means, through the lid openings (115) and the upper section first end flange openings (116) and nuts and washers.

In order to allow gases to enter or escape the stillwell apparatus the gas inlet tube (107) has means for allowing or preventing movement of gases. The gas inlet tube (107) has the valve open position for allowing movement of gas through the gas inlet tube or the valve closed position for preventing movement of gas through the gas inlet tube.

Referring to FIG. 1, the middle section (302) allows for elongation of the length of the stillwell apparatus. If the middle section (302) is inserted there between the upper section second end (111) and the lower section first end (204) by sealingly connecting the middle section second end (303) to the lower section first end (204) with threaded fasteners and then subsequently connecting the middle section first end (304) to the upper section second end (111) with threaded fasteners (112), the length of the stillwell apparatus is extended by the middle section length (300).

The previous embodiments of the inventive Stillwell are frequently installed in existing facilities with some applications in new facilities. Installing new liquid analytical devices into existing facilities may require accommodations or compromises to accomplish the task. Some of the previously described embodiments could be described as surface mounted device. It requires that the instrument/sensor communication cable/means to exit the upper flange assembly whereupon it may become exposed to damage or potentially cause a tripping hazard (unless the installer provides an external guard). Said communication cable/means must then be protected until it is terminated in a protective enclosure, which is most frequently installed on a nearby wall or structure. The issue of having reasonably close proximity to a wall or structure upon which to provide a termination means could have some bearing upon the location of the Stillwell which in actuality may or may not be the best location for the instrument/sensor.

An embodiment that would include the idea of casting the Stillwell upper flange assembly (also called a recessed Stillwell subframe herein) directly into a poured concrete floor (which is also the roof or ceiling of the structure below such as a wetwell, tank or vessel) is shown in FIGS. 5, 6 and 7. This embodiment would provide a connection method to a conduit which would also be imbedded in the same newly poured concrete and therefore allow the communication cable/means to be directed to a remote location such as an adjacent wall whereby the conduit could then exit the concrete and proceed up the wall to a termination box and/or to a transmitter/receiver associated with the instrument/sensor that is located within the Stillwell itself. Also included with this embodiment is a connection means for a conduit, which is also imbedded in the concrete. The conduit and connection means permit installation of a gas sampling access point to a remote location. Upon completed installation, the upper flange assembly would then be flush with the newly poured concrete floor and access to the tubular portion of the Stillwell (and the instrument/sensor within said Stillwell) would be achieved through a removable cover that would, when installed, be flush with the upper flange assembly and therefore also with the poured concrete floor. This embodiment helps to eliminate tripping hazards to persons and thereby to not restrict the location in the room/building that the Stillwell could be installed (example: if the Stillwell upper flange assembly and access cover are flush with the concrete floor, the location of the instrument/sensor could be chosen based upon scientific criteria for the best location and not based upon whether the location poses a safety/tripping hazard. The other advantage is that the by having the conduit which houses the communication cable/means from the sensor/instrument embedded in the concrete, it would be possible to route the same to a more convenient location rather than having the communication cable/means routing being exposed to conditions and hazards in the room/building and possibly posing a safety hazard. This embodiment would also allow for inclusion of intrinsic barriers/explosion proof installation methods which are addressed by the National Electrical Code and by the National Fire Protection Association (these Standards address requirements for wiring and installation methods for equipment installed in hazardous areas).

An embodiment for some separate yet associated devices that could be installed to stabilize the Stillwell in such situations that would require the Stillwell to be installed in an extremely turbulent environment (example: high flow rates directed at the Stillwell). Good design practice is to choose a location for the instrument/sensor and Stillwell that is not in a turbulent location. On occasion, that choice is not an option and therefore I would add the following for consideration;

As shown in FIG. 8, brackets or supports that could be installed on a vertical wall of the wetwell, tank or vessel that would allow the Stillwell to be lowered from above and drop down through the bracket or support in order to stabilize the tubular sections of the Stillwell. These brackets or supports would be designed in such a way as to allow for insertion or removal of the Stillwell as required. (This method would require reasonable proximity to a wall)

The next method would solve the problem of stabilizing the Stillwell when the chosen location is not within reasonable proximity to a wall thereby eliminating the above option as a possibility. Solution; a “base plate” fastened to the floor of the wetwell, tank or vessel into which the open end of the lower most section would fit. The base plate would have stabilizing fins/struts or protrusions rising upwards from the plate that would receive the open end of the lower most section and allow it to “dock” securely into place thereby becoming captive to the floor via the base plate device. The fins/struts or protrusions would be located on the base plate in circumferential manner that would be determined by the outside diameter of the Stillwell structure. These fins/struts or protrusions would be designed in such a manner as to cause very little/minimal restriction to liquid flowing into or out of the Stillwell thereby not restricting contact with the sensor located within the Stillwell. Said fins/struts or protrusions would also be designed to minimize the possibility of becoming fouled with debris so as to not compromise the path of ingress and egress of the measured liquid.

Those skilled in the art will recognize that many modifications are possible without materially departing from the novel teachings and advantages of this invention. Accordingly, all such modifications are intended to be included within the scope of this invention as defined in the following claims.

I claim:

1. A stillwell apparatus for housing an analytical device within a vessel having a cast ceiling, wherein the stillwell apparatus comprises
a) a generally cylindrical shape having an interior for housing the analytical device;
b) an exterior for mounting parallel to said stillwell apparatus a means for cleansing said stillwell apparatus;
c) an upper section, a lower section, and a middle section;
d) the middle section comprises means for extending the length of the stillwell apparatus;
e) said upper section integrally cast into the ceiling of the vessel; and
f) said lower section comprises a plurality of port holes to admit a solution to be analyzed.

2. (canceled)

3. (canceled)

4. (canceled)

5. (canceled)

6. The apparatus of claim 1, wherein the ceiling comprises concrete.

7. The apparatus of claim 1, wherein a communication conduit to the Stillwell is embedded within the ceiling.

8. A stillwell apparatus for housing an analytical device, wherein the stillwell apparatus comprises
a) a generally cylindrical shape having an interior for housing the analytical device;
b) an exterior for mounting parallel to said stillwell apparatus a means for cleansing said stillwell apparatus;
c) an upper section, a lower section, and a middle section;
d) the middle section comprises means for extending the length of the stillwell apparatus;
e) said upper section comprises means for sealingly connecting to an exterior of a vessel;
f) said lower section comprises a plurality of port holes to admit a solution to be analyzed; and,
g) a base plate configured to engage the lower section, wherein the base plate stabilizes the lower section when engaged with the lower section.

9. The apparatus of claim 8, wherein the base plate comprises fins, struts or protrusions that engage with the lower section to hold the lower section in a stable position.
